(19) United States
(12) Patent Application Publication
(10) Pub. No.: US 2009/0190662 A1
(43) Pub. Date: Jul. 30, 2009

(54) METHOD AND APPARATUS FOR ENCODING AND DECODING MULTIVIEW VIDEO

(76) Inventors: Young-O Park, Seongnam-si (KR); Kwan-Woong Song, Seoul (KR); Young-Hun Joo, Yongin-si (KR); Kwang-Pyo Choi, Anyang-si (KR); Yun-Je Oh, Yongin-si (KR); Chang-Su Kim, Seoul (KR); Il-Lyong Jung, Seoul (KR)

Correspondence Address: CHA & REITER, LLC, 210 ROUTE 4 EAST STE 103, PARAMUS, NJ, 07652, US

(21) Appl. No.: 12/362,573

(22) Filed: Jan. 30, 2009

(30) Foreign Application Priority Data
Jan. 30, 2008 (KR) 10-2008-0009730

(51) Int. Cl. H04N 7/26

(52) U.S. Cl. 375/240.16; 375/E07.123

(57) ABSTRACT

A method for encoding a multiview video includes estimating and compensating for a motion between a plurality of pictures from more than one view. A first video captured at a first view becomes a basis and for performing encoding on the first video using the motion estimation and compensation result. Motion estimation and compensation is then performed on a predetermined picture selected from among a plurality of pictures included in a second video captured at a second view being different from that of the first video. The picture from the second view is then encoded using the motion estimation and compensation result. A bit stream is generated including encoded data of the first video and encoded data of the second video.

### CLAIM OF PRIORITY

This application claims the benefit under 35 U.S.C. §119(a) from a Korean Patent Application filed in the Korean Intellectual Property Office on Jan. 30, 2008 and assigned Serial No. 2008-9730, the disclosures of which are incorporated herein by reference in its entirety.

### BACKGROUND OF THE INVENTION

1. Field of the Invention

The present invention relates generally to a method and apparatus for encoding and decoding multiview video. More particularly, the present invention relates to method and apparatus for a multiview video encoder/decoder and compression efficiency.

2. Description of the Related Art

With the recent development of display technology, it is now possible to view realistic 3-dimensional (3D) images or 3D videos. Such 3D images can be realized using multiview videos that are captured at various views. Further, an apparatus for encoding multiview video will encodes videos that are received from a plurality of cameras having different views. Basically, therefore, the multiview video has a considerably high data capacity, and a compression encoding process is essentially required to provide an effective 3D service using multiview videos.

Meanwhile, a human being can recognize a 3D image through a difference between images that come into the left eye and the right eye. Based on such characteristics, a stereoscopic technology has been proposed that can represent 3D images using only left images and right images. In this manner, it is possible to realize 3D images using a lesser amount of data, compared to when a plurality of multiview videos are used. Nevertheless, the left and right stereoscopic images are needed to show one 3D image. However, when two image frames are compressed independently, double the storage space is typically needed when compared with compression of the conventional 2-dimensional (2D) image. Even for transmission of encoded data, a communication bandwidth is twice that of a conventional bandwidth when compared to the conventional 2D image.

Since a stereoscopic image is formed by photographing the same object in different positions at the same time, its left and right images may have a great amount of duplicate information. Therefore, it is possible to increase the compression efficiency by removing the duplicate information. However, an occlusion area may occur between the left image and the right image included in a stereoscopic image due to a difference between views of both eyes. The stereoscopic image should be compressed considering this problem, thus making it impossible to noticeably reduce the transmission bandwidth.

### SUMMARY OF THE INVENTION

An aspect of the present invention is to provide an encoding method and apparatus for increasing compression efficiency of a multiview video, and also provides a method and apparatus for stably decoding encoded multiview video data.

Further, the present invention provides an encoding/decoding method and apparatus for reducing complexity of stereoscopic video while increasing compression efficiency of a multiview video.

According to one exemplary aspect of the present invention, there is provided a method for encoding a multiview video. The encoding method includes, for example, (a) estimating and compensating for a motion between a plurality of pictures included in a first video captured at a first view, which becomes a basis, and performing encoding on the first video using the motion estimation and compensation result; (b) performing motion estimation and compensation on a predetermined picture selected from among a plurality of pictures included in a second video captured at a second view being different from that of the first video, and performing encoding on the second video using the motion estimation and a compensation result; and (c) generating a bit stream including encoded data of the first video and encoded data of the second video.

Preferably, step (b) further includes, for example, estimating a disparity between pictures which time-correspond to each other, from among the plurality of pictures included in the first video and the second video; and the encoding method further includes encoding the pictures included in the second video using the estimated disparity.

Preferably, estimating a disparity includes, for example, estimating a disparity between at least one pair of pictures corresponding to each other.

Preferably, in step (b), the predetermined picture may comprise a picture that is selected at regular intervals of a predetermined unit, and the predetermined unit is set taking into consideration the similarity between pictures included in the second video.

Preferably, the encoding method may further include performing motion estimation and compensation on a predetermined picture selected among the plurality of pictures included in the first video, and performing encoding on the first video using the motion estimation and compensation result.

Preferably, the predetermined picture selected from among the plurality of pictures included in the first video is a picture that corresponds to a different time from that of the predetermined picture selected from among the plurality of pictures included in the second video.

According to another exemplary aspect of the present invention, there is provided a method for decoding a bit stream including an encoded multiview video. The method includes (a) decoding a plurality of pictures included in a first video captured at a first view which becomes a basis, according to an encoding scheme; (b) decoding a selectively encoded picture from among a plurality of pictures included in a second video captured at a second view that is different from a view of the first video, according to the encoding scheme; (c) extracting a motion vector of the selectively encoded picture; (d) restoring a picture skipped in an encoding process from among the pictures included in the second video, using the motion vector acquired in step (c); and (e) decoding the second video by combining the pictures decoded in steps (b) and (d). In other words, a sequence of selected pictures of at least one of the views and second view skips one or more pictures between a beginning and an end of the sequence of a total amount of pictures from a particular view.

Preferably, step (d) may include decoding the picture skipped in the encoding process from among the pictures included in the second video, using the motion vector and a disparity vector between pictures, which time-correspond to each other, included in the first video and the second video.

Preferably, the decoding method may include performing restoration on a block or pixel having no motion or having a motion vector value less than a predetermined value, using the motion vector; and performing restoration on a block or pixel having a motion vector value greater than a predetermined, using the disparity vector.

Preferably, the plurality of pictures included in the first video in step (a) is a picture selected in the encoding process; and step (d) further includes restoring and decoding a picture skipped in the encoding process from among the pictures included in the second video, using the motion vector; and the decoding method further includes (f) decoding the first video by combining the pictures decoded in steps (a) and (d).

Preferably, the predetermined picture selected from among the plurality of pictures included in the first video is a picture which corresponds to a different time from that of the predetermined picture selected from among the plurality of pictures included in the second video.

According to yet another exemplary aspect of the present invention, there is provided an apparatus for encoding a multiview video. The encoding apparatus includes a plurality of encoders for encoding a plurality of multiview videos received from an exterior; an encoding-picture selector for selecting a predetermined picture it will encode, among a plurality of pictures included in at least one of the multiview videos; and a multiplexer for multiplexing data including the encoded multiview videos. The encoders each encode the picture selected by the encoding-picture selector.

Preferably, the encoding apparatus may further include a disparity estimator for estimating a disparity vector between pictures which are included in videos having different views, and time-correspond to each other, and at least one encoder for encoding an enhancement-layer video encodes a picture included in the video using the disparity vector.

Preferably, the encoding-picture selector selects at least one pair of pictures which time-correspond to each other.

Preferably, the predetermined picture that the encoding-picture selector selects, is a picture selected at regular intervals of a predetermined unit.

Preferably, the encoder calculates similarity between pictures included in the videos, and provides the calculation result to the encoding-picture selector; and the encoding-picture selector sets the predetermined unit considering the similarity of the video.

Preferably, the encoding-picture selector alternately selects pictures which time-correspond to each other, from among the pictures included in a plurality of videos.

According to yet another aspect of the present invention, there is provided an apparatus for decoding a multiview video. The decoding apparatus includes a demultiplexer for demultiplexing multiplexed data into a plurality of multiview videos; a plurality of decoders for decoding pictures included in a plurality of encoded multiview videos, and providing a motion vector extracted in a process of restoring pictures for each view; and a picture restorer for estimating a picture skipped in an encoding process using the motion vector from at least one of the decoders. The decoders each restore each video by combining the pictures decoded through the decoding process and the restored pictures.

Preferably, the decoding apparatus further includes a disparity estimator for estimating a disparity vector between pictures which are included in videos having different views, and time-correspond to each other, and the picture restorer estimates a picture skipped in an encoding process using the motion vector and the disparity vector.

### BRIEF DESCRIPTION OF THE DRAWINGS

The above and other exemplary aspects, features and advantages of the present invention will become more apparent from the following detailed description when taken in conjunction with the accompanying drawings in which:

FIG. 1 is a block diagram illustrating a structure of an encoding apparatus according to an exemplary embodiment of the present invention;

FIG. 2 is a diagram illustrating an example of pictures that the encoding apparatus will encode according to an exemplary embodiment of the present invention;

FIG. 3 is a diagram illustrating another example of pictures that the encoding apparatus will encode according to an exemplary embodiment of the present invention;

FIG. 4 is a block diagram illustrating a structure of a multiview video decoding apparatus according to an exemplary embodiment of the present invention;

FIG. 5 is a diagram illustrating an example of multiview video including restored pictures according to an exemplary embodiment of the present invention;

FIG. 6 is a flowchart illustrating a process of encoding multiview video according to an embodiment of the present invention;

FIG. 7 is a flowchart illustrating the detailed process of step 520 in FIG. 6;

FIG. 8 is a flowchart illustrating a process of decoding multiview video according to an exemplary embodiment of the present invention; and

FIG. 9 is a flowchart illustrating the detailed process of step 650 in FIG. 8.

### DETAILED DESCRIPTION

Preferred exemplary embodiments of the present invention will now be described in detail with reference to the annexed drawings. In the following description, a detailed description of known functions and configurations incorporated herein may have been omitted for clarity and conciseness so as not to obscure appreciation of the subject matter of the present invention by a person of ordinary skill in the art.

The present invention operates in part to selectively skip some pictures in a process of encoding a plurality of pictures included in each of a plurality of videos constituting a multiview video. Further, the present invention is featured by stably restoring the pictures skipped in the encoding process, and decoding a plurality of videos included in the multiview video. The present invention provides an exemplary embodiment for implementing such characteristics.

An exemplary embodiment of the present invention provides, as a multiview video, a stereoscopic image including a left image and a right image. Although a stereoscopic image including two videos is provided herein as a multiview video, this is not intended to limit the scope of the present invention, and the present invention can be applied to a multiview video including a plurality of videos through various modifications.

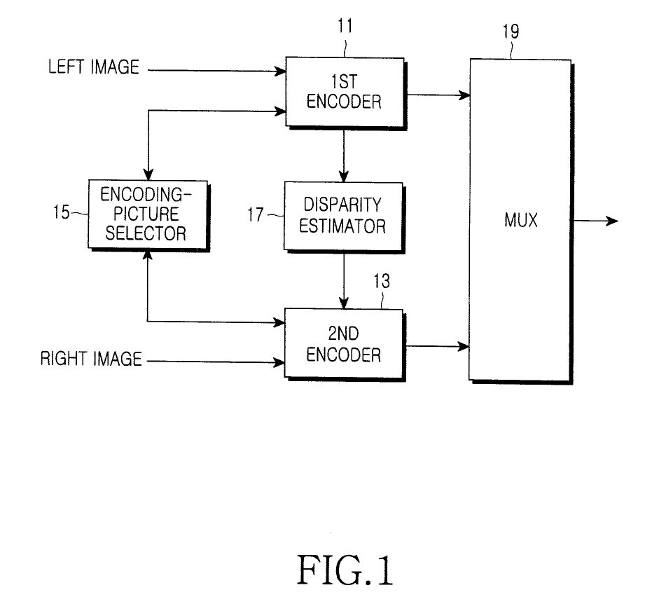

FIG. 1 is a block diagram illustrating a structure of an encoding apparatus according to an exemplary embodiment of the present invention. Referring to FIG. 1, an encoding apparatus according to an exemplary embodiment of the present invention includes a first encoder 11, a second encoder 13, an encoding-picture selector 15, and a multiplexer 19.

The first encoder 11 comprises a device for encoding a left image, or base-layer video, included in a stereoscopic image, and the second encoder 13 comprises a device for encoding a right image, or enhancement-layer video, included in the stereoscopic image.

For example, the first encoder 11 and the second encoder 13 may comprise encoding devices for performing Discrete Cosine Transform (DCT), quantization, intra-prediction, motion estimation, and motion compensation on a plurality of pictures included in the left image and the right image, respectively. Further, the first encoder 11 and the second encoder 13 may comprise devices for encoding videos according to the normal Moving Picture Experts Group (MPEG) scheme.

Both the first encoder 11 and the second encoder 13 perform encoding on the pictures to be encoded, selected by the encoding-picture selector 15. Further, the first encoder 11 and the second encoder 13 can output the encoded pictures along with information indicating positions of pictures skipped in the encoding process. For example, the information may indicate the order of the pictures skipped in the video including sequentially arranged pictures, and/or a rule in which the pictures are skipped.

The encoding-picture selector 15 selects pictures that it will encode from among a plurality of pictures included in each video, taking into account the view and time of a multiview video received from the exterior. Herein, the left image and the right image are images generated by photographing the same object at different views at the same time, and it is preferable that the left image and the right image include chrominance information of pictures constituting the images, and information on time synchronization for the pictures.

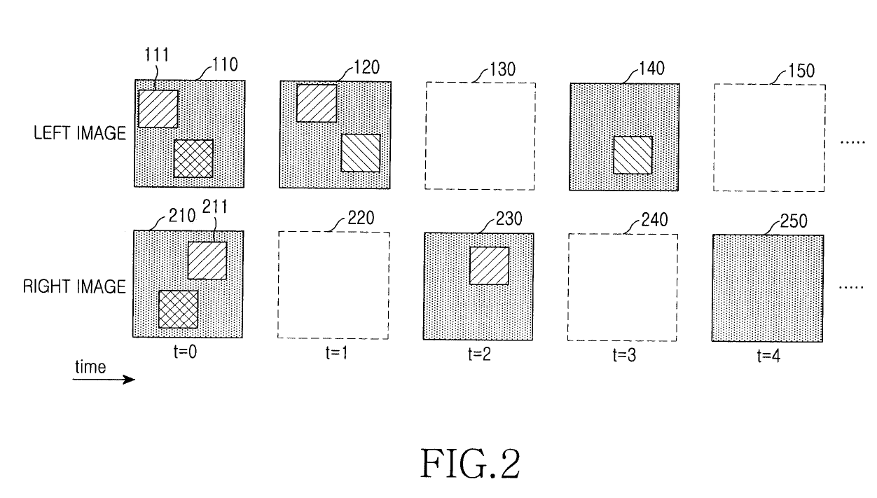

FIG. 2 is a diagram illustrating a part of a series of pictures included in a left image and a right image according to an exemplary embodiment of the present invention. Referring to FIG. 2, shown are 5 pictures 110, 120, 130, 140 and 150 included in the left image, and 5 pictures 210, 220, 230, 240 and 250 included in the right image. The pictures 110, 120, 140, 210, 230 and 250 indicated by the solid lines in FIG. 2 are pictures the encoding-picture selector 15 selects for encoding, and the pictures 130, 150, 220 and 240 shown by the dotted lines are pictures which are skipped in the encoding process. That is, the encoding-picture selector 15 provides the first encoder 11 for encoding the left image, with an instruction to perform encoding on the three pictures 110, 120 and 140, and provides the second encoder 13 for encoding the right image, with an instruction to perform encoding on the three pictures 210, 230 and 250. It should be understood by a person of ordinary skill in the art that three is not a required number but chosen for this particular example to explain an embodiment of the invention.

It is preferable that the encoding-picture selector 15 selects a picture at regular intervals of a predetermined unit. It is also preferable that the encoding-picture selector 15 selects at least one picture from a number of pictures having different views at the same time. For example, referring to FIG. 2, the predetermined unit may be 2. Further, in order to select at least one of pictures having different views at the same time, the encoding-picture selector 15 selects pictures 120 and 140 including even-time information among the pictures included in the left image, and selects pictures 230 and 250 including odd-time information from among the pictures included in the right image.

The predetermined unit is subject to change according to information indicating similarity between pictures included in an image. To this end, the encoding apparatus according to an exemplary embodiment of the present invention may further include a similarity extractor (not shown) for extracting the similarity between pictures included in an image. The encoding-picture selector 15 can variously set the predetermined unit taking the similarity between pictures, extracted by means of the similarity extractor. Further, the similarity extractor can be included in each of the first encoder 11 and the second encoder 13.

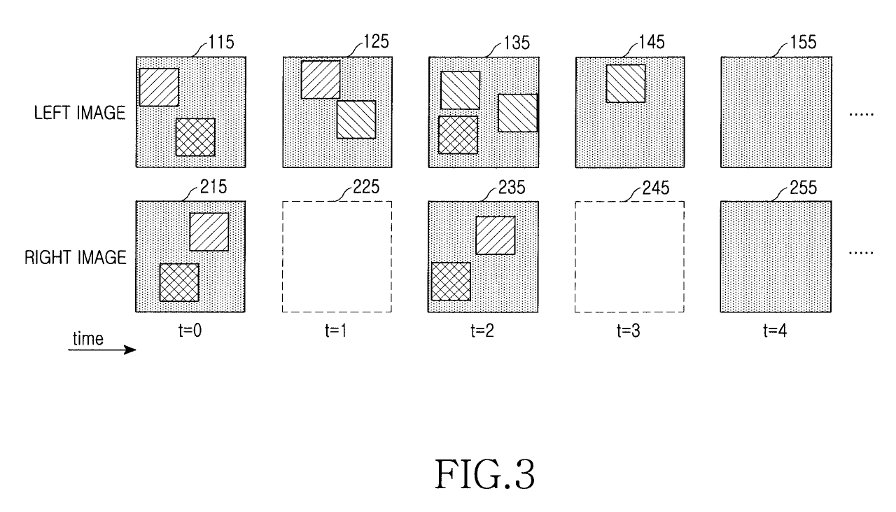

Although the encoding-picture selector 15 alternately selects herein the pictures included in the left image (base-layer video) and the right image (enhancement-layer video) as shown in FIG. 2, this selection does not form a mandatory pattern of the claimed invention and is not intended in any possible way to limit the scope of the present invention. For example, as shown in FIG. 3, the encoding-picture selector 15 can select all of the pictures 115, 125, 135, 145 and 155 included in the left image, and alternately select particular pictures 215, 235 and 255 among the pictures 215, 225, 235, 245 and 255 included in the right image, as well as virtually in any order. That is, the picture selection by the encoding-picture selector 15 is subject to change considering compression efficiency of encoding.

Furthermore, according to another exemplary embodiment of the present invention, it is preferable that the second encoder 13 perform encoding using a disparity vector between at least one pair of pictures corresponding to the same time, among the pictures included in the left image and the right image. The one pair of pictures can be pictures (e.g., 110 and 210 of FIG. 2) which become a basis of inter-mode encoding. To this end, the encoding apparatus according to an exemplary embodiment of the present invention may include a disparity estimator 17 for estimating disparity between at least one pair of pictures corresponding to the same time among the pictures included in the left image and the right image. That is, the disparity estimator 17 calculates a disparity vector in units of particular blocks between the one pair of pictures (e.g., 110 and 210 of FIG. 2), for example, in units of particular macro blocks.

Referring back to FIG. 1, the multiplexer 19 multiplexes encoded multiview videos output from the first encoder 11 and the second encoder 13.

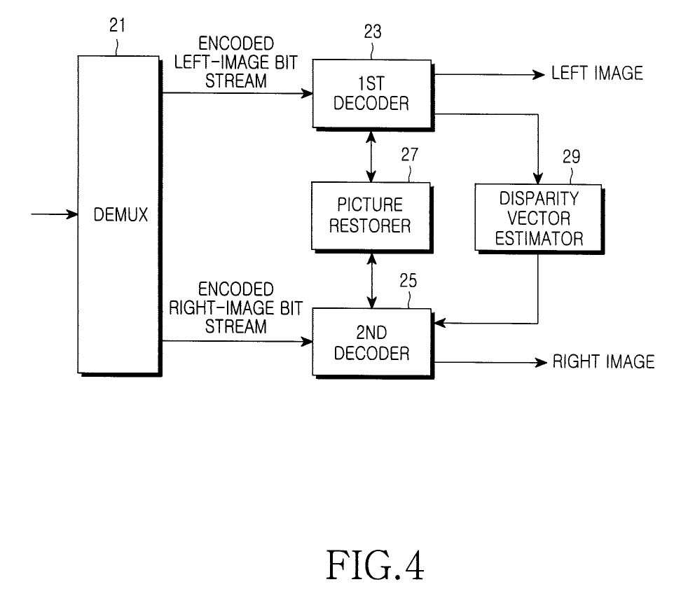

FIG. 4 is a block diagram illustrating a structure of a multiview video decoding apparatus according to an exemplary embodiment of the present invention. Referring to now FIG. 4, a multiview video decoding apparatus according to this exemplary embodiment of the present invention includes a demultiplexer 21, a first decoder 23, a second decoder 25, and a picture restorer 27.

The demultiplexer 21 demultiplexes encoded multiplexed data. For example, when a first video and a second video included in a multiview video are encoded and multiplexed in an encoding process, the demultiplexer 21 demultiplexes the multiplexed data, thus acquiring the data generated by encoding the first video and the second video.

The first decoder 23 and the second decoder 25 are devices for decoding a left image (base-layer video) and a right image (enhancement-layer video) included in a stereoscopic image, respectively. The first decoder 23 and the second decoder 25 can be devices for decoding videos according to a decoding scheme, e.g., MPEG scheme, corresponding to the encoding scheme of the encoder for encoding the videos.

Further, the first decoder 23 and the second decoder 25 receive pictures skipped in the video encoding process, provided from the picture restorer 27, and output videos in which the provided pictures are inserted.

Meanwhile, according to an exemplary embodiment of the present invention, in a process of encoding a stereoscopic image, at least some pictures out of a plurality of pictures included in a video are skipped. The invention performs encoding on the stereoscopic image together with location information of the skipped pictures. For example, the location information of the skipped pictures can be information on the order of the pictures skipped in the video including sequentially arranged pictures, and/or on a rule in which the pictures are skipped.

Still referring to FIG. 4, the picture restorer 27 restores the skipped pictures in accordance with the location information of the pictures skipped in the encoding process. The picture restorer 27 operates, for example, by receiving the picture information necessary for restoring the skipped pictures, provided from the first decoder 23 and the second decoder 25, and provides the restored pictures back to the first decoder 23 and the second decoder 25. The picture restorer 27 can restore the skipped pictures using a motion vector value inserted in the encoding process.

A detailed description will now be made of a process in which the picture restorer 27 restores the skipped pictures.

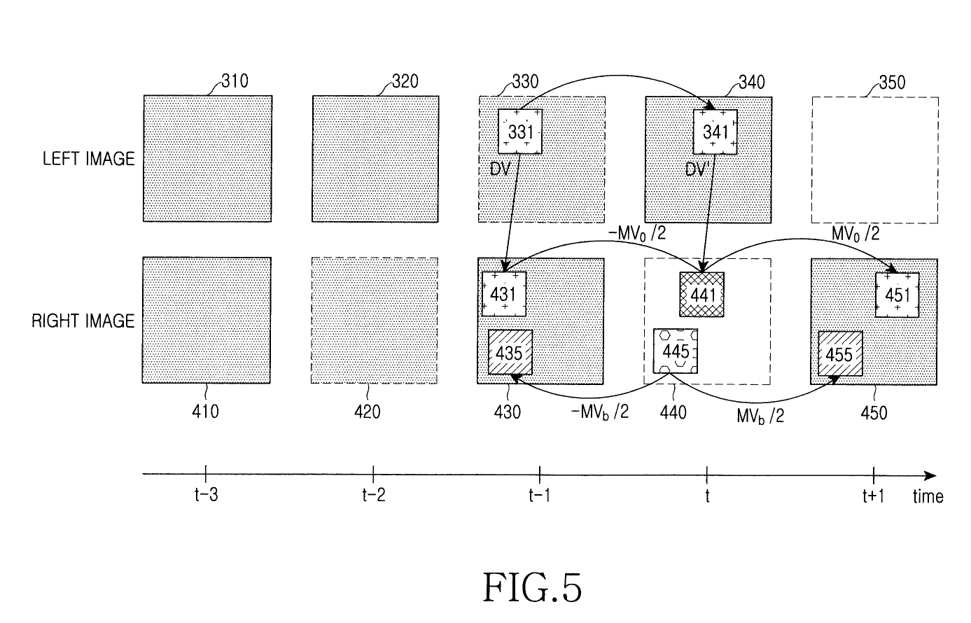

FIG. 5 is a diagram illustrating an exemplary structure of a multiview video including restored pictures according to a particular exemplary embodiment of the present invention. Referring to FIG. 5, the pictures shown by dotted outlines, which are the pictures that are skipped in the encoding process, are pictures that will undergo restoration in a decoding process, while the pictures shown by solid outlines indicate the pictures which were normally encoded in the encoding process. In FIG. 5, the horizontal axis represents the time axis. Further, the squares included in the pictures represent particular blocks included in the pictures.

For example, when restoring a picture 450 located at a particular time (t+1) of the right image, the second decoder 25 requests the picture restorer 27 (shown in FIG. 4) to restore a skipped picture 440, determining that the previous picture 440 of the picture 450 is skipped. Then the picture restorer 27 receives pictures 430 and 450 neighboring the picture 440 to be restored, provided from the second decoder 25, checks motion vectors between particular blocks included in the provided pictures 430 and 450, i.e., a motion vector between a first block 431 and a fifth block 451 and a motion vector between a second block 435 and a sixth block 455, and then designates values obtained by halving the motion vectors as motion vectors of a third block 441 and a fourth block 445.

Further, in the second decoder 25, achieving a stable restoration is possible for the blocks including objects having no motion or a relatively small amount of motion, but the blocks including objects having a relatively larger amount of motion can show unstable restoration. Therefore, it is preferable that the second decoder 25 restores the blocks including objects having no motion or relatively small motion using the motion vectors, and restores the blocks including objects having larger motion using disparity vectors.

For example, referring to FIG. 5, since a motion vector is 0 between the second block 435 and the sixth block 455, the second decoder 25 restores the fourth block 445 to the same value as the second block 435. Further, since there is a motion vector between the first block 431 and the fifth block 451, the second decoder 25 restores the third block 441 using a disparity vector between the restoration-completed pixels among the pixels neighboring to the position where the third block 441 to be restored is to be inserted. To this end, it is preferable that the multiview video decoding apparatus according to an exemplary embodiment of the present invention further optionally includes a disparity vector extractor 29 for estimating the disparity vector between pictures included in videos having different views.

A description will now be made of an encoding method and a decoding method according to an exemplary embodiment of the present invention.

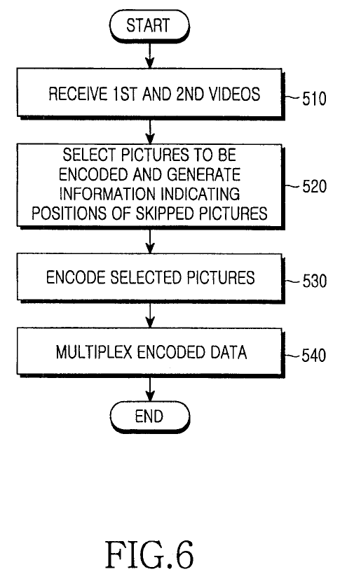

FIG. 6 is a flowchart comprising one illustrative process of encoding multiview video according to an exemplary embodiment of the present invention.

In step 510, an encoding apparatus sequentially receives a plurality of pictures included in a multiview video, i.e., included in the left image and the right image.

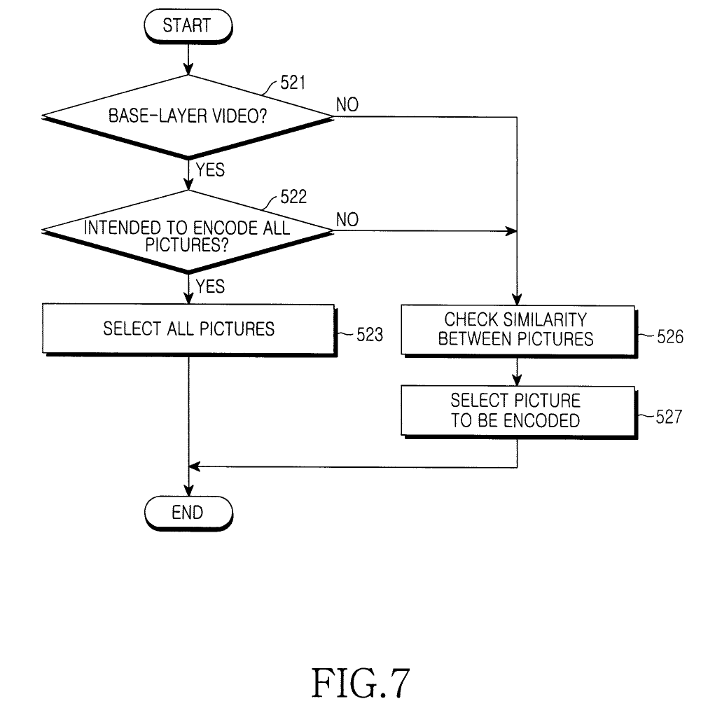

Next, in step 520, the encoding apparatus selects picture it will encode, among the plurality of pictures included in the left image and the right image. Further, in step 520, the encoding apparatus generates information indicating positions of skipped pictures. A detailed description of step 520 will be given below with reference to FIG. 7.

In step 530, the encoding apparatus encodes each video including the pictures selected in step 520. For example, step 530 can be an encoding process for performing DCT, quantization, intra-prediction, motion estimation, and motion compensation on a plurality of the selected pictures included in the left image and the right image. For example, step 530 can be a process of encoding the left image and the right image separately according to the normal MPEG scheme. Further, in step 530, it is preferable that the encoding apparatus encodes information indicating positions of the skipped pictures, together with information indicating whether the pictures are skipped or not, depending on the information indicating positions of the skipped pictures.

In addition, in step 530, it is also preferable that for encoding, the encoding apparatus estimates a disparity vector between at least one pair of pictures corresponding to the same instant in time from among the pictures included in the left image and the right image. For example, the one pair of pictures can be pictures (e.g., 110 and 210 of FIG. 2) which become a basis of inter-mode encoding.

Further, in step 530, the encoding apparatus can encode the pictures (e.g., 110 to 150 of FIG. 2) included in the left image, or base-layer video, using a motion vector. Besides, in step 530, the encoding apparatus can encode the picture (210 of FIG. 2) which becomes a basis of inter-mode encoding, from among the pictures included in the right image, or enhancement-layer video, using a disparity vector with the picture (110 of FIG. 2) included in the left image, and encode the pictures 230 and 250 included in the right image using a motion vector.

Finally, in step 540, the encoding apparatus multiplexes the data encoded in step 530 for the left image and the right image.

FIG. 7 is a flowchart illustrating the detailed process of step 520 in FIG. 6. It should be noted that steps 522 and 526 are preferable but not necessarily required to practice the present invention.

In step 521, the encoding apparatus checks as to whether or not an input video is a base-layer video (e.g., left image). Upon determination that the input video comprises a base-layer video, the encoding apparatus proceeds to step 522, and if the input video is an enhancement-layer video (e.g., right image) other than the base-layer video, the encoding apparatus proceeds to step 526.

At step 522, which is preferable but not required step, it is determined whether it is intended to encode all the pictures. For example, if it is determined in step 522 that the encoding apparatus will encode all pictures included in the base-layer video, the encoding apparatus proceeds to step 523, and if it is determined that the encoding apparatus will selectively encode pictures included in the base-layer video, the encoding apparatus proceeds to step 527. Step 522 can be set at the discretion of the user, before the encoding apparatus encodes multiview video.

The encoding apparatus proceeds to step 523 where it performs a process of selecting all pictures included in the base-layer video prior to encoding on all pictures included in the base-layer video as in step 530 shown in FIG. 6. Therefore, step 523 corresponds to a process of selecting all pictures included in the base-layer video.

Step 526 preferably may be performed to determine check a relation between pictures included in the enhancement-layer video, i.e., similarity between pictures included in the video.

In step 527, there is a selection by the encoding apparatus of a plurality of pictures that will be encoded at step 530 (FIG. 6), the pictures being selected from among the plurality of pictures included in the enhancement-layer video (e.g., right image). Step 527 can correspond to a process of selecting pictures to be skipped or selected from among the plurality of pictures included in the video at intervals of a predetermined period.

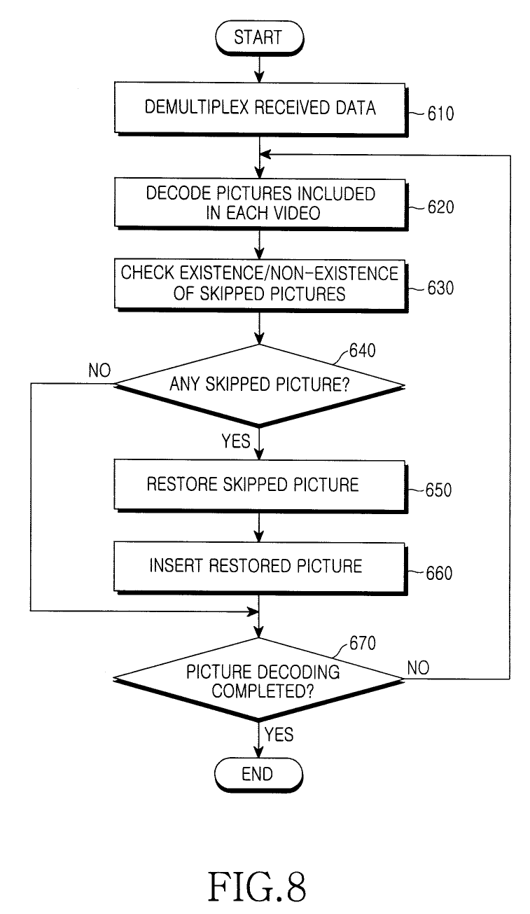

FIG. 8 is a flowchart illustrating a process of decoding multiview video according to an exemplary embodiment of the present invention.

In step 610, a decoding apparatus receives a multiview video, provided from the exterior, which is encoded by an encoding method according to an exemplary embodiment of the present invention, and demultiplexes the provided data.

In step 620, the decoding apparatus decodes the encoded data of the left image and the right image using a decoding scheme corresponding to the encoding scheme in which the videos are encoded. For example, step 620 can correspond to a process of performing decoding according to the MPEG scheme in which the left image and the right image are encoded.

The decoding method according to the present invention provides a method for decoding the encoded data, from which some pictures among the plurality of pictures included in the left image and the right image are skipped in the encoding process. Further, when pictures are skipped in the encoding process, indicators indicating the skip of the pictures can be inserted in the positions where the pictures are skipped. As an alternative to inserting the indicators indicating the skip of pictures, it is possible to insert information indicating a pattern (e.g., period at which pictures are skipped) in which the skipped pictures or non-skipped pictures are located.

Based on the information inserted in the encoding process, the decoding apparatus checks in step 630 whether there is any skipped picture between the decoded pictures. Step 630 can be a process of checking, for examples, indicators that identify positions of the skipped pictures, or, for example, the period at which the pictures are skipped, provided in the information included in the encoded data.

In step 640, the decoding apparatus determines whether there is any skipped picture between the currently decoded pictures, depending on the result acquired in step 630. If there is any skipped picture between the currently decoded pictures, the decoding apparatus proceeds to step 650, and if there is no skipped picture, the decoding apparatus proceeds to step 670.

In step 650, the decoding apparatus restores the skipped picture using the information generated in a process of decoding pictures time-neighboring the skipped picture, i.e., previous and next pictures of the skipped picture. For example, the information generated in the decoding process can be a motion vector defined in units of a macro block between the previous and next pictures of the skipped picture. This step will be subsequently discussed in more detail.

In step 660, the decoding apparatus inserts the picture restored in step 650 in the picture-skipped position so that the pictures included in the videos can be sequentially decoded.

Finally, in step 670, the decoding apparatus checks whether decoding has been completed for all pictures included in the videos. If decoding has been completed for all pictures included in the videos, the decoding apparatus ends the decoding of multiview video, and if decoding has not been completed for all pictures included in the videos, the decoding apparatus repeats steps 620 to 660.

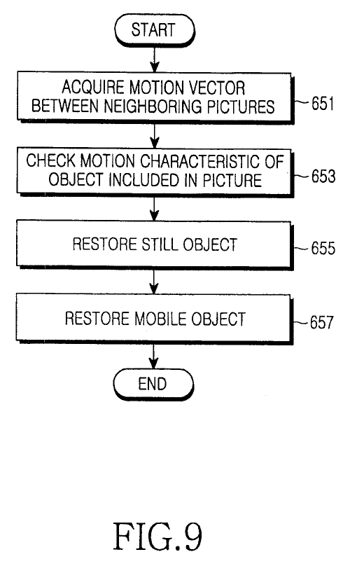

FIG. 9 is a flowchart illustrating the detailed process of step 650 in FIG. 8. With reference to FIG. 9, a description will now be made of step 650 of restoring the skipped pictures.

In step 651, a decoding apparatus acquires a motion vector defined in units of a macro block between the pictures (e.g., 430 and 450 of FIG. 5) time-neighboring the picture (e.g., 440 of FIG. 5) it will restore. Since the motion vector defined in units of a macro block is inserted in the process of encoding pictures, it can be acquired from the process of decoding pictures.

In step 653, the decoding apparatus checks a motion characteristic of an object included in the picture, using the motion vector defined in units of a macro block. For example, when a motion vector (MV) between the second block 435 and the sixth block 455 of FIG. 5 is 0, the decoding apparatus can determine that an object corresponding to the second block 435 has no motion. However, when there is a motion vector between the first block 431 and the fifth block 451 as in the first block 431 and the fifth block 451, the decoding apparatus can determine that an object corresponding to the first block 431 has motion. In this way, in step 653, the decoding apparatus checks motion vectors for a plurality of blocks included in the picture, and analyzes motion characteristics of objects included in the picture according thereto. That is, in step 653, based on the motion characteristics, the decoding apparatus analyzes whether each object is a mobile object having larger motion, or a still object having no motion or a smaller (i.e. lesser) amount of motion. Determining whether the motion level is high (larger) or low (smaller) can be achieved by checking whether a motion vector value between the blocks exceeds a predetermined value.

Next, in step 655, the decoding apparatus restores the still object. That is, in step 655, the decoding apparatus restores a block with motion vector=0, using the same value as that of the neighboring blocks, and restores a block having a fine motion vector, using a value determined by halving a value of the motion vector.

In step 657, the decoding apparatus restores the mobile object. That is, the decoding apparatus restores the block having a greater motion vector, using a value determined by halving (i.e. reducing by approximately half) the value of the motion vector.

Further, stable restoration is possible for the objects having no motion or less motion, but the objects having large motion show instable restoration. Therefore, in step 657, it is preferable that the decoding apparatus estimates a disparity vector for the pixel, whose restoration was totally completed in step 655, in the block (e.g., third block 441 of FIG. 5) whose restoration has not been completed, and then completes restoration of the pixel whose restoration has not been completed, using estimated disparity vector.

As is apparent from the foregoing description, the video encoding/decoding method and apparatus according to the present invention can implement high-efficiency compression of multiview video, thereby advantageously reducing a size of encoded data of the multiview video.

Furthermore, the reduction in size of encoded data of the multiview video can enable not only real-time transmission of the multiview video with the limited resources, but also real-time playback of the multiview video.

While the invention has been shown and described with reference to a certain preferred exemplary embodiments thereof, it will be understood by those skilled in the art that various changes in form and details may be made from the examples shown and described herein without departing from the spirit and scope of the invention as defined by the appended claims.

What is claimed is:

1. A method for encoding a multiview video, the method comprising:
(a) estimating and compensating for a motion between a plurality of pictures included in a first video captured at a first view which becomes a basis, and for performing encoding on the first video using the estimated motion and compensation result of the first video;
(b) performing motion estimation and compensation on predetermined pictures selected from among a plurality of pictures included in a second video captured at a second view being different from that of the first video, and performing encoding on the second video using the estimated motion and compensation result of the second video; and
(c) generating a bit stream including encoded data of the first video and encoded data of the second video.

2. The method of claim 1, wherein step (b) further comprises:
estimating a disparity between pictures which time-correspond to each other from among the plurality of pictures included in the first video and the second video; and
wherein the method further comprises encoding the pictures included in the second video using the estimated disparity.

3. The method according to claim 1, wherein a sequence of selected pictures of at least one of the first view and second view skips one or more pictures between a beginning and an end of the sequence of a particular view.

4. The method of claim 2, wherein estimating a disparity comprises:
estimating a disparity between at least one pair of pictures corresponding to each other.

5. The method of claim 1, wherein in step (b), the predetermined pictures comprise a picture which is selected at regular intervals of a predetermined unit.

6. The method of claim 5, wherein the predetermined unit is set by considering similarity between pictures included in the second video.

7. The method claim 1, further comprising:
performing motion estimation and compensation on a predetermined picture selected from among the plurality of pictures included in the first video, and performing encoding on the first video using the motion estimation and compensation result.

8. The method of claim 7, wherein the predetermined picture selected from among the plurality of pictures included in the first video is a picture which corresponds to a different time from that of the predetermined picture selected from among the plurality of pictures included in the second video.

9. A method for decoding a bit stream including an encoded multiview video, the method comprising:
(a) decoding a plurality of pictures included in a first video captured at a first view which becomes a basis, according to an encoding scheme;
(b) decoding a selectively encoded picture among a plurality of pictures included in a second video captured at a second view being different from that of the first video, according to the encoding scheme;
(c) extracting a motion vector of the selectively encoded picture in (b);
(d) restoring a picture skipped in an encoding process among the encoded plurality of pictures included in the second video, using the motion vector acquired in step (c); and
(e) decoding the second video by combining the pictures decoded in steps (b) and (d).

10. The method of claim 9, wherein step (d) comprises:
(i) restoring the picture skipped in the encoding process from among the pictures included in the second video by using the motion vector and a disparity vector between pictures, which time-correspond to each other, included in the first video and the second video.

11. The method of claim 10, further comprising:
performing restoration on a block or pixel having no motion or having a motion vector value less than a predetermined value, using the motion vector; and
performing restoration on a block or pixel having a motion vector value greater than a predetermined, using the disparity vector.

12. The method of claim 9, wherein the plurality of pictures included in the first video in step (a) comprises a picture selected in the encoding process,
wherein step (d) further comprises restoring a picture skipped in the encoding process among the pictures included in the second video, by using the motion vector, and
wherein the method further comprises (f) decoding the first video by combining the pictures decoded in step (a) and restored in step (b).

13. The method of claim 12, wherein the predetermined picture selected from among the plurality of pictures included in the first video comprises a picture which corresponds to a different time from that of the predetermined picture selected from among the plurality of pictures included in the second video.

14. A method for performing encoding and decoding on an encoded multiview video, the method comprising:
performing encoding and decoding;
wherein performing encoding comprises:
(a) estimating and compensating for a motion between a plurality of pictures included in a first video captured at a first view which becomes a basis, and performing encoding on the first video using the motion estimation and compensation result;
(b) performing motion estimation and compensation on a predetermined picture selected from among a plurality of pictures included in a second video captured at a second view being different from that of the first video, and performing encoding on the second video using the motion estimation and compensation result; and
(c) generating a bit stream including encoded data of the first video and encoded data of the second video; and
wherein performing decoding comprises:
(d) decoding the plurality of pictures included in the first video, according to the encoding of step (a);
(e) decoding the picture which is selectively encoded in step (b), according to the encoding of step (b);
(f) extracting a motion vector of the picture which is selectively encoded in step (e);
(g) restoring a picture skipped in the encoding process among the pictures included in the second video, using the motion vector acquired in step (f); and
(h) decoding the second video by combining the pictures decoded in step (e) and restored in step (g).

15. An apparatus for encoding a multiview video, the apparatus comprising:
a plurality of encoders for encoding a plurality of multiview videos received from an exterior;
an encoding-picture selector for selecting a predetermined picture for encoding from among a plurality of pictures included in at least one of the multiview videos; and
a multiplexer for multiplexing data including the encoded multiview videos;
wherein the encoders each encode the picture selected by the encoding-picture selector.

16. The apparatus of claim 15, further comprising:
a disparity estimator for estimating a disparity vector between pictures which are included in videos having different views, and time-correspond to each other;
wherein at least one encoder for encoding an enhancement-layer video encodes a picture included in the video using the disparity vector.

17. The apparatus of claim 16, wherein the encoding-picture selector selects at least one pair of pictures which time-correspond to each other.

18. The apparatus of claim 15, wherein the predetermined picture that the encoding-picture selector selects, is a picture selected at regular intervals of a predetermined unit.

19. The apparatus of claim 18, wherein the encoder calculates similarity between pictures included in the videos, and provides the calculation result to the encoding-picture selector; and
wherein the encoding-picture selector sets the predetermined unit considering the similarity of the video.

20. The apparatus of claim 15, wherein the encoding-picture selector alternately selects pictures which time-correspond to each other from among the pictures included in a plurality of videos.

21. An apparatus for decoding a multiview video, the apparatus comprising:
a demultiplexer for demultiplexing multiplexed data into a plurality of multiview videos;
a plurality of decoders for decoding pictures included in a plurality of encoded multiview videos, and providing a motion vector extracted in a process of restoring pictures for each view; and
a picture restorer for estimating a picture skipped in an encoding process using the motion vector from at least one of the decoders;
wherein the decoders each restore each video by combining the pictures decoded through the decoding process and the restored pictures.

22. The apparatus of claim 21, further comprising:
a disparity estimator for estimating a disparity vector between pictures which are included in videos having different views, and time-correspond to each other;
wherein the picture restorer estimates a picture skipped in an encoding process using the motion vector and the disparity vector.

23. An apparatus for performing encoding and decoding on a multiview video, the apparatus comprising:
an encoding apparatus and a decoding apparatus;
wherein the encoding apparatus comprises:
a plurality of encoders for encoding a plurality of multiview videos received from an exterior; an encoding-picture selector for selecting a predetermined picture to be encoded from among a plurality of pictures included in at least one of the multiview videos; and
a multiplexer for multiplexing data including the encoded multiview videos;
wherein the encoders each encode the picture selected by the encoding-picture selector; and
wherein the decoding apparatus comprises:
a demultiplexer for demultiplexing multiplexed data into a plurality of multiview videos;
a plurality of decoders for decoding pictures included in a plurality of encoded multiview videos, and providing a motion vector extracted in a process of restoring pictures for each view; and a picture restorer for estimating a picture skipped in an encoding process using the motion vector from at least one of the decoders;
wherein the decoders each restore each video by combining the pictures decoded through the decoding process and the restored pictures.

24. The apparatus according to claim 23, wherein the plurality of encoders for encoding said plurality of multiview videos received from an exterior each encode a respective view of the plurality of multiview videos.

25. The apparatus according to claim 23, wherein the plurality of decoders for decoding pictures included in said plurality of encoded multiview videos each decode a respective view of the plurality of encoded multiview videos.
